(19) United States
(12) Patent Application Publication
(10) Pub. No.: US 2008/0088941 A1
(43) Pub. Date: Apr. 17, 2008

(54) Display device having optical lens system

(75) Inventors: Hua Jiang, Shenzhen (CN); Wen-Hui Yao, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TEECHNOLOGY (SHENZHEN) CO., LTD.; INNOLUX DISPLAY CORP.

(21) Appl. No.: 11/974,779

(22) Filed: Oct. 16, 2007

(30) Foreign Application Priority Data
Oct. 16, 2006 (TW) 95138081

(51) Int. Cl. G02B 13/08

(52) U.S. Cl. 359/668

(57) ABSTRACT

An exemplary display device (2) includes a display system configured for displaying images and an optical lens system (23) adjacent to the display system. The optical lens system includes a first lens unit (231) having a first optical correction rate in a first correction axis and a second lens unit (233) adjacent to the first lens unit. The second lens unit has a second optical correction rate in a second correction axis that is different from the first correction axis.

### FIELD OF THE INVENTION

The present invention relates to a display device having an optical lens system configured to correct image distortions that would otherwise be formed by the display device.

### GENERAL BACKGROUND

Commonly used display devices include cathode ray tubes (CRTs), liquid crystal displays (LCDs), plasma display panels (PDPs), and so on. Proportions of images presented by the display devices are determined by the following three parameters. The first parameter is the applicable displaying standard of data signals inputted to the display device, which may for example be the national television system committee (NTSC) standard, the phase alternation line (PAL) standard or the high definition television (HDTV) standard. The second parameter is the picture aspect ratio. The third parameter is the pixel aspect ratio.

Thus, when the standard displaying system and the picture aspect ratio are fixed, the pixel aspect ratio determines the proportions of the images presented by a display device. For example, in order to gain an optimum image proportion, the pixel aspect ratio of an NTSC standard display device having a picture aspect ratio of 4:3 is set to 1.0. Referring to FIG. 4, when a display device 10 having the above parameters displays a circular image, an ideal circular image is achieved.

However, because of difficulties inherent in the technology and process involved in fabricating the display device 10, the exact ideal value for the pixel aspect ratio may not be achieved. In such cases, images generated by the display device 10 may be distorted. As shown in FIG. 5, when an NTSC standard display device 11 having a picture aspect ratio of 4:3 and a pixel aspect ratio of 1.067 displays a circular image, the generated image is visibly enlarged in width and narrowed in height. Referring also to FIG. 6, when the pixel aspect ratio of the standard NTSC display device 11 is 0.9, the generated image is visibly enlarged in height and narrowed in width.

What is needed, therefore, is a display device that can overcome the above-described deficiencies.

### SUMMARY

In one preferred embodiment, a display device includes a display system configured for displaying images and an optical lens system adjacent to the display system. The optical lens system includes a first lens unit having a first optical correction rate in a first correction axis and a second lens unit adjacent to the first lens unit. The second lens unit has a second optical correction rate in a second correction axis that is different from the first correction axis.

Other novel features and advantages will become more apparent from the following detailed description when taken in conjunction with the accompanying drawings. In the drawings, all the views are schematic.

### BRIEF DESCRIPTION OF THE DRAWINGS

FIG. 1 is an exploded, isometric view of a display device according to an exemplary embodiment of the present invention, the display device including a first cylindrical lens and a second cylindrical lens.

FIG. 2 is an isometric view of the first cylindrical lens of FIG. 1, showing dimensional characteristics thereof.

FIG. 3 is an isometric view of the second cylindrical lens of FIG. 1, showing dimensional characteristics thereof.

FIG. 4 is a view of a circular graphic presented by a conventional display device having a pixel aspect ratio of 1.0.

FIG. 5 is a view of a circular graphic presented by another conventional display device having a pixel aspect ratio of 1.067.

FIG. 6 is a view of another circular graphic presented by the same display device as that of FIG. 5, but when the display device has a pixel aspect ratio of 0.9.

### DETAILED DESCRIPTION OF PREFERRED EMBODIMENTS

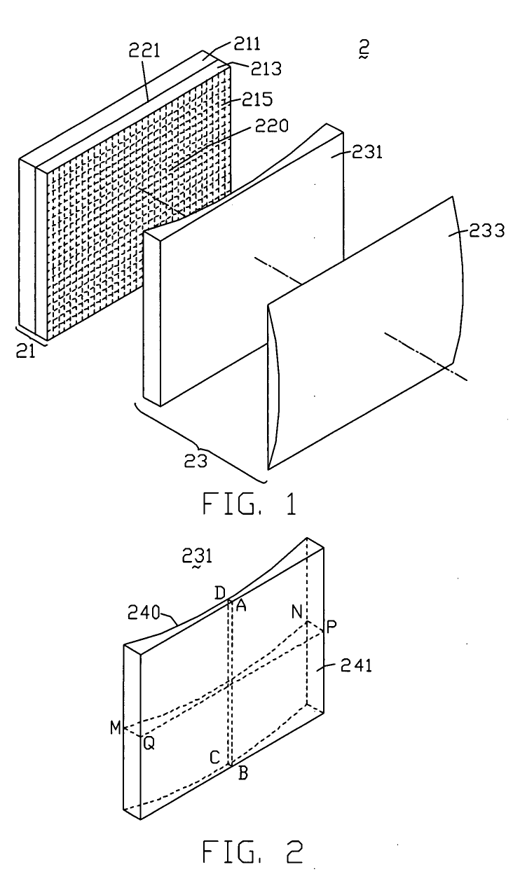

Referring to FIG. 1, a display device 2 according to an exemplary embodiment of the present invention is shown. The display device 2 includes a display system (not labeled) configured to display images, and an optical lens system 23 disposed adjacent to the display system.

In the illustrated embodiment, the display system is a liquid crystal display which includes a liquid crystal panel 21 and a backlight module (not shown). The backlight module is configured to provide uniform light beams to the liquid crystal panel 21. The liquid crystal panel 21 includes a thin film transistor (TFT) substrate 211, a color filter (CF) substrate 213 arranged in a parallel to the TFT substrate 211, and a liquid crystal layer (not visible) sandwiched between the TFT substrate 211 and the CF substrate 213. The liquid crystal panel 21 includes a plurality of pixel units 215 arranged in a matrix. The CF substrate 213 includes a displaying surface 220 adjacent to the optical lens system 23, and a bottom surface 221. The bottom surface 221 and the displaying surface 220 are at opposite sides of the CF substrate 213. The TFT substrate 211 is generally adjacent to the bottom surface 221, and is configured to provide pixel voltage signals to each pixel unit 215. Typically, due to difficulties inherent in the technology and processes involved in fabricating the liquid crystal panel 21, an actual pixel aspect ratio of the liquid crystal panel 21 is not the same as an ideal pixel aspect ratio.

The optical lens system 23 includes a first cylindrical lens 231 having negative focal power, and a second cylindrical lens 233 having positive focal power. The first cylindrical lens 231 is located adjacent to the displaying surface 220. The second cylindrical lens 233 is opposite to the first cylindrical lens 231. A generatrix of the second cylindrical lens 233 is perpendicular to that of the first cylindrical lens 231. Light beams emitted from the display system pass through the first cylindrical lens 231 and the second cylindrical lens 233 in sequence and thereby form a virtual image.

Referring to FIG. 2, the first cylindrical lens 231 includes a concave cylindrical surface 240 adjacent to the displaying surface 220, and a first plane surface 241. The first plane surface 241 and the concave cylindrical surface 240 are at the opposite sides of the first cylindrical lens 231. A curvature of the concave cylindrical surface 240 is determined by an amount of distortion in width of an image displayed by the liquid crystal panel 21. A distance between the first plane surface 241 and the displaying surface 220 is less than a focal length of the first cylindrical lens 231. A first meridional planar axis of symmetry ABCD of the first cylindrical lens 231 is perpendicular to the first plane surface 241. A vertical axis of the first cylindrical lens 231 parallel to a height dimension of the liquid crystal panel 21 is located in the first meridional planar axis of symmetry ABCD. A first sagittal planar axis of symmetry MNPQ of the first cylindrical lens 231 is perpendicular to the first meridional planar axis of symmetry ABCD. A horizontal axis of the first cylindrical lens 231 parallel to a width dimension of the liquid crystal panel 21 is located in the first sagittal planar axis of symmetry MNPQ. Incident light beams parallel to the first meridional planar axis of symmetry ABCD keep their original optical paths when they pass through the first cylindrical lens 231. Incident light beams parallel to the first sagittal planar axis of symmetry MNPQ are refracted as if passing through a concave spherical lens when they pass through the first cylindrical lens 231.

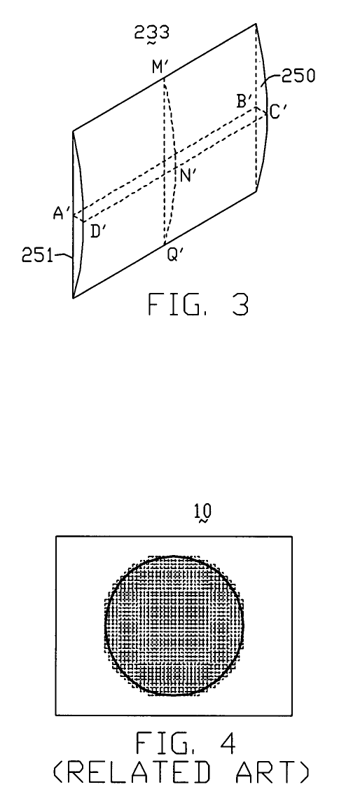

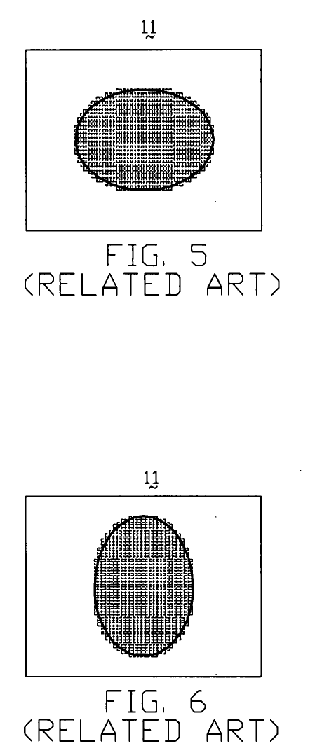

Referring to FIG. 3, the second cylindrical lens 233 includes a second plane surface 251 adjacent to the first plane surface 241, and a convex cylindrical surface 250. The convex cylindrical surface 250 and the second plane surface 251 are at opposite sides of the second cylindrical lens 233. A curvature of the convex cylindrical surface 250 is determined by an amount of distortion in height of an image displayed by the liquid crystal panel 21. A second meridional planar axis of symmetry A′B′C′D′ is perpendicular to the second plane surface 251. A horizontal axis of the second cylindrical lens 233 parallel to a width dimension of the liquid crystal panel 21 is located in the second meridional planar axis of symmetry A′B′C′D′. A second sagittal planar axis of symmetry M′N′Q′ of the second cylindrical lens 233 is perpendicular to the second meridional planar axis of symmetry A′B′C′D′. A vertical axis of the second cylindrical lens 233 is located in the second sagittal planar axis of symmetry M′N′Q′. Incident light beams parallel to the second meridional planar axis of symmetry A′B′C′D′ keep their original optical paths when they pass through the second cylindrical lens 233. Incident light beams parallel to the second sagittal planar axis of symmetry M′N′Q′ are refracted as if passing through a convex spherical lens when they pass through the second cylindrical lens 233.

When the liquid crystal panel 21 displays a first distorted circular image which is enlarged in width and narrowed in height, light beams emitted from the pixel units 215 corresponding to the first distorted circular image pass through the optical lens system 23 thereby forming a virtual circular image. The light beams parallel to the first sagittal planar axis of symmetry MNPQ are refracted by the first cylindrical lens 231; thereby, a width of the virtual circular image is reduced by a certain reduction rate. The light beams parallel to the second sagittal planar axis of symmetry M′N′Q′ are refracted by the second cylindrical lens 233; thereby, a height of the virtual circular image is enlarged by a certain enlargement rate. The reduction rate and the enlargement rate are respectively determined by the curvatures of the first cylindrical lens 231 and the second cylindrical lens 233. Therefore the virtual circular image obtained is close to or even achieves an ideal circular image. That is, by the setting of the appropriate curvatures according to the amounts of distortion of the first distorted circular image, the virtual circular image is an appropriate correction of the first distorted circular image.

In addition, when the liquid crystal panel 21 displays a second distorted circular image which is enlarged in height and narrowed in width, the first cylindrical lens 231 and the second cylindrical lens 233 are simultaneously rotated 90 degrees along a main optical axis thereof. Further, when the liquid crystal panel 21 displays a distorted circular image which is enlarged both in height and in width, the optical lens system 23 can be formed by two concave cylindrical lenses. In such case, sagittal planar axes of symmetry of the two concave cylindrical lenses are perpendicular to each other. When the liquid crystal panel 21 displays a distorted circular image which is narrowed both in the height and in width, the optical lens system 23 can be formed by two convex cylindrical lenses. In such case, sagittal planar axes of symmetry of the two convex cylindrical lenses are perpendicular to each other.

In summary, the optical lens system 23 can correct distortions of a primary image generated by reason of the liquid crystal panel 21 having a deviation in the pixel aspect ratio of the pixel units 215. Thereby, a virtual image close to an ideal image is generated, the virtual image being displayed by the display device 2 for viewing by users. Furthermore, in mass production of the display device 2, utilizing the optical lens system 23 to correct image distortion can be advantageous. For example, the optical lens system 23 can circumvent the need to undertake costly re-designing of the pixel aspect of the display device 2. In another example, the optical lens system 23 can circumvent the need to undertake costly upgrading, revamping or replacement of expensive fabrication equipment.

In an alternative embodiment, the optical lens system 23 can be formed by a first lens unit and a second lens unit. Each of the first and second lens units is formed by a plurality of thin lenses. The first lens unit has a first correction rate (i.e., a reduction rate or an enlargement rate) in a first correction axis, and the second lens unit has a second correction rate (i.e. a reduction rate or an enlargement rate) in a second correction axis that is oriented differently from the first correction axis. In an alternative embodiment, the optical lens system 23 can be a single anamorphic lens. The anamorphic lens has correction rates in different correction axes, thereby correcting distortion levels in corresponding axes. Further, even though the above exemplary display system is a liquid crystal display, other display systems can similarly incorporate the optical lens system 23. Such other display systems include PDPs, CRTs, etc.

It is believed that the present embodiments and their advantages will be understood from the foregoing description, and it will be apparent that various changes may be made thereto without departing from the spirit or scope of the invention or sacrificing all of its material advantages, the examples hereinbefore described merely being preferred or exemplary embodiments of the invention.

What is claimed is:

1. A display device comprising:
a display system configured for generating images; and
an optical lens system adjacent to the display system, the optical lens system comprising:
a first lens unit having a first optical correction rate in a first correction axis; and
a second lens unit adjacent to the first lens unit, the second lens unit having a second optical correction rate in a second correction axis that is different from the first correction axis.

2. The display device as claimed in claim 1, wherein the first lens unit has negative focal power and the second lens unit has positive focal power.

3. The display device as claimed in claim 1, wherein each of the first lens unit and the second lens unit comprises at least one optical lens.

4. The display device as claimed in claim 3, wherein the first lens unit comprises a concave cylindrical lens, and the second lens unit comprises a convex cylindrical lens.

5. The display device as claimed in claim 4, wherein the concave cylindrical lens comprises a concave cylindrical surface and a first plane surface, which are at opposite sides of the concave cylindrical lens.

6. The display device as claimed in claim 5, wherein a distance between the first plane surface and the display system is less than a focal length of the concave cylindrical lens.

7. The display device as claimed in claim 4, wherein the convex cylindrical lens comprises a convex surface and a second plane surface, which are at opposite sides of the convex cylindrical lens.

8. The display device as claimed in claim 4, wherein a generatrix of the concave cylindrical lens is perpendicular to a generatrix of the convex cylindrical lens.

9. The display device as claimed in claim 8, wherein a vertical axis of the concave cylindrical lens is parallel to a height dimension of the display system.

10. The display device as claimed in claim 8, wherein a vertical axis of the convex cylindrical lens is parallel to a width dimension of the display system.

11. The display device as claimed in claim 2, wherein each of the first lens unit and the second lens unit comprises a concave cylindrical lens.

12. The display device as claimed in claim 2, wherein each of the first lens unit and the second lens unit comprises a convex cylindrical lens.

13. The display device as claimed in claim 1, wherein the first correction axis is perpendicular to the second correction axis.

14. The display device as claimed in claim 1, wherein the display system is selected from the group consisting of a liquid crystal display, a plasma display panel, and a cathode ray tube.

15. The display device as claimed in claim 1, wherein the first lens unit comprises a plurality of thin films, and the second lens unit comprises a plurality of thin films.

16. A display device comprising:
a display system configured for displaying images; and
an optical lens system adjacent to the display system, the optical lens system comprising at least one anamorphic lens having at least two optical correction rates in at least two different correction axes.

17. The display device as claimed in claim 16, wherein the optical lens system comprises a first cylindrical lens adjacent to the display system, and a second cylindrical lens adjacent to the first cylindrical lens.

18. The display device as claimed in claim 17, wherein a generatrix of the first cylindrical lens is perpendicular to a generatrix of the second cylindrical lens.

19. The display device as claimed in claim 17, wherein the first cylindrical lens has positive focal power and the second cylindrical lens has negative focal power.

20. The display device as claimed in claim 17, wherein a sagittal planar axis of symmetry of the first cylindrical lens is perpendicular to a sagittal planar axis of symmetry of the second cylindrical lens.
